(19) United States
(12) Patent Application Publication
(10) Pub. No.: US 2011/0304527 A1
(43) Pub. Date: Dec. 15, 2011

(54) COMPUTER-IMPLEMENTED METHODS, CARRIER MEDIA, AND SYSTEMS FOR DISPLAYING AN IMAGE OF AT LEAST A PORTION OF A WAFER

(76) Inventors: Sean Wu, Fremont, CA (US); Charles Richards, Palo Alto, CA (US); Rajagopalan Ramachandran, San Jose, CA (US); Min Ouyang, Mountain View, CA (US)

(21) Appl. No.: 11/855,581

(22) Filed: Sep. 14, 2007

(51) Int. Cl. G09G 3/36

(52) U.S. Cl. 345/92

(57) ABSTRACT

Various computer-implemented methods, carrier media, and systems for displaying an image of at least a portion of a wafer are provided. One computer-implemented method for displaying an image of at least a portion of a wafer includes separately storing different portions of an image of substantially an entire wafer acquired by inspection of the wafer. The different portions of the image correspond to different areas on the wafer. The method also includes displaying in a user interface (UI) only the different portions requested by a user.

### BACKGROUND OF THE INVENTION

1. Field of the Invention

The present invention generally relates to computer-implemented methods, carrier media, and systems for displaying an image of at least a portion of a wafer. Certain embodiments relate to a computer-implemented method that includes separately storing different portions of an image of substantially an entire wafer and displaying in a user interface only the different portions requested by a user.

2. Description of the Related Art

The following description and examples are not admitted to be prior art by virtue of their inclusion in this section.

Fabricating semiconductor devices such as logic and memory devices typically includes processing a substrate such as a semiconductor wafer using a large number of semiconductor fabrication processes to form various features and multiple levels of the semiconductor devices. For example, lithography is a semiconductor fabrication process that involves transferring a pattern from a reticle to a resist arranged on a semiconductor wafer. Additional examples of semiconductor fabrication processes include, but are not limited to, chemical-mechanical polishing (CMP), etch, deposition, and ion implantation. Multiple semiconductor devices may be fabricated in an arrangement on a single semiconductor wafer and then separated into individual semiconductor devices.

Inspection processes are used at various steps during a semiconductor manufacturing process to detect defects on wafers to promote higher yield in the manufacturing process and thus higher profits. Inspection has always been an important part of fabricating semiconductor devices. However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary since even relatively small defects may cause unwanted aberrations in the semiconductor devices.

The results of inspection are essentially useless unless the results can be conveyed to a user in a meaningful manner and/or can be converted to a form useable by another system or method. In some instances, in addition to its other tasks, a software component called an “algorithm engine” converts raw data obtained from a wafer inspection system. The algorithm engine converts that data into a rectangular matrix of pixel intensity values, called the “image” of the wafer. Another software component, called the “user interface” (UI), displays those pixel intensities on a computer monitor.

The general approach of the method described above for displaying an image of a wafer is still valid. However, this method of performing the display function has several fundamental limitations. For instance, the method described above represents the image of the wafer as one atomic piece of data in the computer software. Using a single image software object is acceptable for prior inspection systems because the size of that image object was small enough to fit within the memory (e.g., RAM) of a computer. More modern inspection systems will generate much larger data sizes, and the high resolution data generated by such systems for entire wafers will be too large to practically fit within the memory of a computer. Portions of that wafer data can be saved as image files and loaded offline for display. However, it is not possible (or not practical) to navigate through the whole wafer image using such image files.

The prior method also uses an algorithm engine and a UI coupled into a single piece of software that runs on a single computer. The total throughput of the inspection system can be improved by using multiple image computers (IMCs) and running the same algorithm engine on each of them in parallel.

Furthermore, it is typical for a UI to be designed or targeted for a specific computer platform. However, it is desirable for the software implementing an algorithm engine to be neutral to the choice of platform. This neutrality allows the algorithm to be built on whatever platform yields the best performance. But because the prior method couples the UI and algorithm engine as one piece of software, it effectively restricts the choice of the platform for the engine to that of the UI.

Accordingly, it would be advantageous to develop computer-implemented methods, carrier media, and systems for efficient display of an image of a wafer, which is acquired from an inspection system, by accommodating relatively large data sizes, by allowing navigation through an image of substantially the entire wafer, by enabling higher throughput of such display, and by allowing flexibility in the platform on which the software for such displaying is implemented such that the platform that allows the best performance can be used.

### SUMMARY OF THE INVENTION

The following description of various embodiments of methods, carrier media, and systems is not to be construed in any way as limiting the subject matter of the appended claims.

One embodiment relates to a computer-implemented method for displaying an image of at least a portion of a wafer. The method includes separately storing different portions of an image of substantially an entire wafer acquired by inspection of the wafer. The different portions of the image correspond to different areas on the wafer. The method also includes displaying in a user interface (UI) only the different portions requested by a user.

In one embodiment, the different areas do not overlap on the wafer. In another embodiment, the different areas are adjacent to one another on the wafer such that the different areas cover substantially the entire wafer. In an additional embodiment, the different areas include rectangular areas on the wafer arranged in a two-dimensional grid.

In one embodiment, separately storing the different portions of the image includes separately storing the different portions in one or more storage media in one or more image computers (IMCs). In another embodiment, separately storing the different portions of the image and the displaying step are performed by different software modules.

In an additional embodiment, the displaying step includes sending one or more requests for the different portions requested by the user to one or more IMCs. In a further embodiment, the displaying step includes receiving a request from the user for the different portions to be displayed in the UI, distributing the request to one or more IMCs, and receiving the different portions requested by the user from the one or more IMCs.

In one embodiment, the displaying step includes displaying only the different portions requested by the user in different arrangements in the UI. In another embodiment, the displaying step includes temporarily storing only the different portions requested by the user and using only the temporarily stored different portions to display only the different portions requested by the user in different arrangements in the UI.

In one embodiment, the displaying step includes displaying only the different portions requested by the user at different resolutions in the UI. In another embodiment, separately storing the different portions of the image includes separately storing the different portions at a resolution at which the different portions are acquired. In an additional embodiment, the method includes, prior to receiving a request from the user for the displaying step, generating one or more additional portions corresponding to each of the different portions by altering a resolution of each of the different portions and separately storing the one or more additional portions with the corresponding different portions. In a further embodiment, the method includes receiving a request from the user for the displaying step and a resolution at which the displaying step is to be performed and, subsequent to the receiving step and prior to the displaying step, changing a resolution of only the different portions requested by the user to the resolution at which the displaying step is to be performed.

In one embodiment, the displaying step is not limited by a size of data that can be displayed simultaneously in the UI. In another embodiment, a time in which the displaying step is performed is proportional to a size of a display device on which the UI is displayed and is independent of a size of raw data corresponding to the image of substantially the entire wafer acquired by the inspection of the wafer.

In one embodiment, separately storing the different portions of the image is performed for multiple wafers. In one such embodiment, the displaying step includes simultaneously displaying only the different portions of the images of two or more of the multiple wafers requested by the user in the UI.

In another embodiment, if requested by the user, the displaying step includes displaying the image of substantially the entire wafer by displaying all of the different portions of the image. In an additional embodiment, if requested by the user, the displaying step includes displaying the image of substantially the entire wafer by displaying all of the different portions of the image with additional information generated for the wafer overlaid thereon.

Each of the steps of the method described above may be further performed as described further herein. In addition, each of the embodiments of the method described above may include any other step(s) of any other method(s) described herein. Furthermore, each of the embodiments of the method described above may be performed by any of the systems described herein.

Another embodiment relates to a carrier medium that includes program instructions executable on a computer system for displaying an image of at least a portion of a wafer. The method includes separately storing different portions of an image of substantially an entire wafer acquired by inspection of the wafer. The different portions of the image correspond to different areas on the wafer. The method also includes displaying in a UI only the different portions requested by a user.

The carrier medium described above may be further configured as described herein. The steps of the computer-implemented method may be performed as described further herein. In addition, the computer-implemented method for which the program instructions are executable may include any other step(s) of any other method(s) described herein.

An additional embodiment relates to a system configured to display at least a portion of a wafer. The system includes an inspection system configured to acquire an image of substantially an entire wafer by inspecting the wafer. The system also includes a computer system configured to separately store different portions of the image. The different portions of the image correspond to different areas on the wafer. The computer system is also configured to display in a UI only the different portions requested by a user. The system may be further configured according to any embodiment(s) described herein.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a schematic diagram illustrating a block diagram of one embodiment of a system that can be used to perform one or more embodiments of a computer-implemented method described herein;

FIG. 2 is a schematic diagram illustrating a plan view of one embodiment of different areas on a wafer that correspond to different portions of an image of substantially the entire wafer that are separately stored as described herein; and

FIG. 3 is a block diagram illustrating one embodiment of a carrier medium that includes program instructions executable on a computer system for performing one or more embodiments of a computer-implemented method described herein and one embodiment of a system configured to display at least a portion of a wafer.

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

As used herein, the term “wafer” generally refers to substrates formed of a semiconductor or non-semiconductor material. Examples of such a semiconductor or non-semiconductor material include, but are not limited to, monocrystalline silicon, gallium arsenide, and indium phosphide. Such substrates may be commonly found and/or processed in semiconductor fabrication facilities.

A wafer may include one or more layers formed upon a substrate. For example, such layers may include, but are not limited to, a resist, a dielectric material, a conductive material, and a semiconductive material. Many different types of such layers are known in the art, and the term wafer as used herein is intended to encompass a wafer including all types of such layers.

One or more layers formed on a wafer may be patterned or unpatterned. For example, a wafer may include a plurality of dies, each having repeatable patterned features. Formation and processing of such layers of material may ultimately result in completed devices. Many different types of devices such as integrated circuits (ICs) may be formed on a wafer, and the term wafer as used herein is intended to encompass a wafer on which any type of device known in the art is being fabricated.

Although embodiments are described herein with respect to wafers, it is to be understood that the embodiments may be used for displaying an image of at least a portion of another specimen such as a reticle, which may also be commonly referred to as a mask or a photomask. Many different types of reticles are known in the art, and the terms “reticle,” “mask,” and “photomask” as used herein are intended to encompass all types of reticles known in the art.

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals.

In general, the embodiments described herein include displaying an image of at least a portion of a wafer. In addition, the embodiments described herein may be used for whole wafer imaging. In particular, the embodiments described herein may be used for efficient display of an image of a semiconductor wafer, which is acquired from an inspection system.

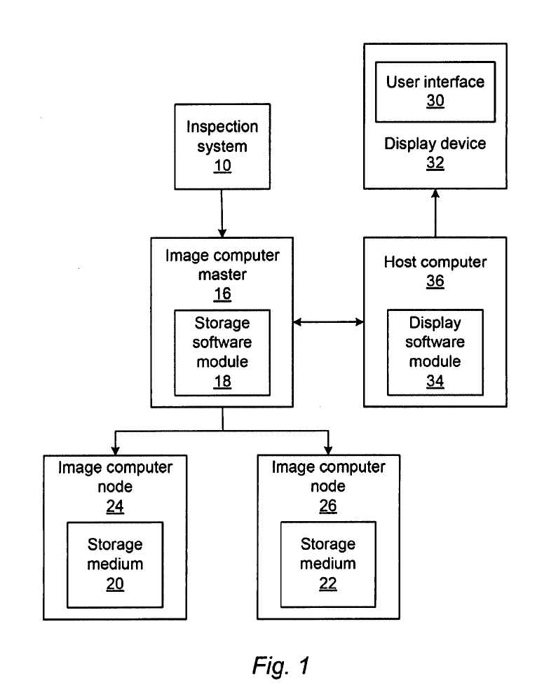

One embodiment of a computer-implemented method for displaying an image of at least a portion of a wafer includes separately storing different portions of an image of substantially an entire wafer acquired by inspection of the wafer. The inspection of the wafer may be performed in any suitable manner using any inspection system (e.g., using inspection system 10 shown in FIG. 1) that can generate or acquire image data for wafers. In addition, the embodiments described herein may or may not include inspecting the wafer. For example, the embodiments described herein may include inspecting the wafer by scanning the wafer with light and detecting light scattered and/or reflected from the wafer and/or by performing inspection in any other suitable manner. However, the embodiments described herein may be performed using output generated by inspection of a wafer that is performed by another method or system. For example, output generated by inspection performed by another method or system may be acquired by the embodiments described herein in any suitable manner (e.g., from an inspection system, from a storage medium in which the output was stored by the inspection system, etc.).

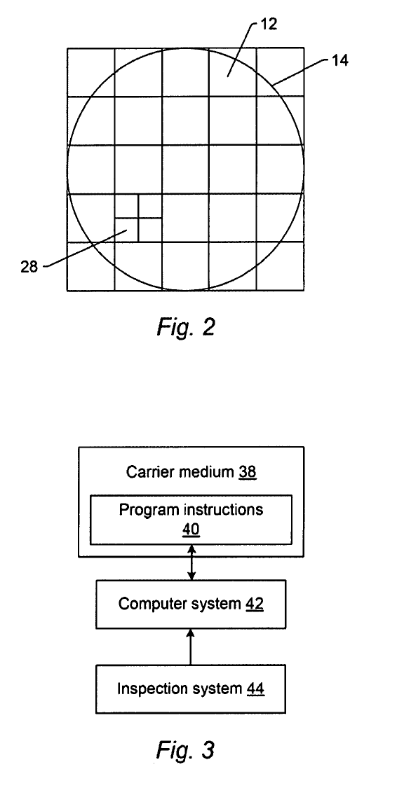

The different portions of the image correspond to different areas on the wafer. In an additional embodiment, the different areas include rectangular areas on the wafer arranged in a two-dimensional grid. For example, as shown in FIG. 2, the different portions of the image may correspond to different areas 12 on wafer 14. In addition, as shown in FIG. 2, the different areas are arranged in a two-dimensional grid or array on the wafer. In some embodiments, the method may include separating an image of substantially the entire wafer into the different portions. For example, separating the image of substantially the entire wafer may include tessellating an image of substantially the entire wafer into a rectangular grid of adjacent different portions (or sub-images), which are also referred to herein as “wafer tiles.” Therefore, instead of storing and representing an image of a whole wafer as a single image, the method may include tessellating a wafer image into different portions that can be individually stored and displayed and collectively represent an image of the whole wafer. Tessellating a wafer image may be performed in real time (e.g., during inspection of the wafer or as the image data is acquired) or after all of the image data for the wafer has been acquired (e.g., after inspection of the wafer).

The number of tiles into which the whole wafer image is tessellated may vary depending on, for example, one or more parameters of the inspection system that acquired the image of the wafer. The one or more parameters may include, for example, the resolution or pixel size of the inspection system.

The concept of “image tiles” is not new. For instance, it has been used for storage of satellite images. However, using such “image tiles” is new to the application for semiconductor wafer images. In particular, this is the first application of image tessellation for the purpose of displaying images of semiconductor wafers.

In one embodiment, the different areas do not overlap on the wafer. In particular, as described above, the different portions may correspond to different areas on the wafer that are adjacent to one another on the wafer. In another embodiment, the different areas are adjacent to one another on the wafer such that the different areas cover substantially the entire wafer. For example, as shown in FIG. 2, different areas 12 extend across substantially the entire wafer. In this manner, the image of substantially the entire wafer may be tessellated into a number of different portions such that an image of any area or the entire area of the wafer may be displayed by displaying the corresponding portions as described further herein. In addition, although a certain number of different areas are shown in FIG. 2, the image of substantially the entire wafer may be separated into any suitable number of different portions that correspond to any suitable number of different areas on the wafer.

In one embodiment, separately storing the different portions of the image includes separately storing the different portions in one or more storage media in one or more image computers (IMCs). For example, the different portions of the image may be stored on a disk array or another suitable storage medium attached to or included in one or more IMCs. The embodiments may be performed using different numbers of IMCs. In addition, the system can be constructed with the same number of IMCs but with a different partitioning of data between the IMCs.

In one such embodiment, as shown in FIG. 1, inspection system 10 may be coupled to “image computer master” 16 or “IMC master.” In particular, inspection system 10 may be coupled to IMC master 16 in a manner such that an image of substantially an entire wafer acquired by inspection system 10 can be sent to IMC master 16. The IMC master may have any suitable configuration and may include any suitable hardware and/or software. In addition, the IMC master may be replaced with any other suitable computer system.

As shown in FIG. 1, IMC master 16 may include storage software module 18. Storage software module 18 may be configured to separate the image of substantially the entire wafer into different portions as described further herein. In addition, storage software module 18 may be configured to separately store the different portions of the image. In some embodiments, the storage software module may be configured to separately store different portions of the image in one or more storage media (e.g., storage media 20 and 22) in one or more IMCs (e.g., “IMC nodes” 24 and 26, respectively). In addition, more than one different portion may be separately stored in one storage medium as described further herein. Storage software module 18 may have any suitable configuration. Storage media 20 and 22 may include any suitable storage media known in the art, and IMC nodes 24 and 26 may include any suitable IMCs, hardware, and/or software. In addition, the IMC nodes may be replaced with any other suitable computer systems.

In this manner, the image may be separated into the different portions by the same software that separately stores the different portions (e.g., by storage software module 18). In one such example, the data for the different portions generated by an algorithm engine may be stored by the algorithm engine on a disk array attached to an individual IMC. The algorithm engine may have any suitable configuration. The image data corresponding to the different portions may be separately stored on disk as image files in a file system and may be identified by filename. Because some operating systems do not efficiently handle a relatively large number of files in the same directory, the wafer data may be divided into “macro-blocks” (e.g., larger scale rectangular areas). For example, areas 12 shown in FIG. 2 may correspond to macro-blocks, and each of the areas may be divided into areas 28 as shown in FIG. 2 that correspond to “micro-blocks.” Although one of the macro-blocks is shown in FIG. 2 separated into 4 micro-blocks, the macro-blocks may be separated into any suitable number of micro-blocks. Each macro-block may correspond to a directory in the file system.

In some embodiments, separately storing the different portions includes separately storing the different portions at a resolution at which the different portions are acquired. For example, the resolution at which the different portions are acquired may be the native pixel resolution of the inspection system. In this manner, the resolution at which the different portions are acquired may vary depending on the algorithm engine of the inspection system, which generates wafer data at some native pixel resolution, and which can be configured to store the different portions at this same resolution. As such, the data that is stored for the different portions may include native resolution data.

At any given time, the user may not need to use the UI to view every pixel of image data for the entire wafer. Instead, the user may need to view only a few of the wafer tiles. In this manner, the method includes displaying in a UI only the different portions requested by a user. A request from the user for the wafer tiles the user wishes to be displayed may be received in any suitable manner and in any suitable format by the embodiments described herein. The number of wafer tiles required for display may be relatively small, and the size of each individual wafer tile may be relatively small. For example, the number of wafer tiles that are displayed at any one time may include 16 tiles arranged in a 4 tile by 4 tile two-dimensional array. In another example, the size of each individual wafer tile may be on the order of about 256 pixels by about 256 pixels. Therefore, whole wafer image display becomes practical using the embodiments described herein. In addition, the user has access to a huge volume of stored wafer data (e.g., different portions that correspond to different areas covering substantially the entire wafer stored in one or more IMCs), but the user can request only those pixels the user needs to see right at that moment.

The method may include displaying the different portions of the image requested by the user in UI 30 shown in FIG. 1. The UI may have any suitable configuration. In addition, the UI may be displayed using display device 32 shown in FIG. 1, which may include any suitable display device (e.g., a computer monitor) known in the art.

In one embodiment, separately storing the different portions of the image as described above and displaying the different portions are performed by different software modules. For example, the software used for storing and the software used for display may be decoupled so that one software module (e.g., an algorithm engine) creates and stores all of the wafer data on one or more IMCs and a separate piece of UI software runs on a “host computer.”

In one such example, as shown in FIG. 1, the method may include using storage software module 18 on IMC master 16 for separately storing the different portions of the image as described above and using display software module 34 or “UI software” on host computer 36 for displaying the different portions of the image requested by the user in the UI. Display software module 34 may be configured to perform such display according to any of the embodiments described herein. Host computer 36 may have any suitable configuration known in the art. In addition, host computer 36 may be replaced with any other suitable computer system known in the art that may be configured to perform one or more steps of one or more method embodiments described herein.

In another embodiment, displaying the different portions includes sending one or more requests for the different portions requested by the user to one or more IMCs. In an additional embodiment, displaying the different portions includes receiving a request from the user for the different portions to be displayed in the UI, distributing the request to one or more IMCs, and receiving the different portions requested by the user from the one or more IMCs. In this manner, the query and receipt of different portions of a wafer image may be distributed over a cluster.

For example, if the UI software is responsible for managing what appears on the computer monitor, the UI software may generate requests for wafer tiles that it will need to display. These requests may be sent through a network to the one or more IMCs (e.g., IMC nodes 24 and 26 shown in FIG. 1). In addition, if multiple IMCs are used (each responsible for some partition of the whole wafer image), then host computer 36 may send a request for a wafer tile to IMC master 16 that is configured to delegate that request to the appropriate individual IMC node (to the node on which the requested data is stored). Therefore, the IMC master may be aware of the partitioning scheme used for the wafer image data, which is a configurable design decision. The host computer and the IMC master may be coupled in any suitable manner such that requests can be sent from the host computer to the IMC master and such that image data may be sent from the IMC master to the host computer.

For the network communication technology, message passing interface (MPI) may be used between the IMC master and the individual IMC nodes. Such technology may be used because it is commonplace for high-performance computing and is easily configured for different topologies, platforms, and network connections. In addition, sockets programming may be used for the connection between the host computer and the IMC master (e.g., if different operating systems are used).

The embodiments described herein may be used for relatively easy and quick navigating through the whole wafer image. For example, in some embodiments, displaying the different portions includes displaying only the different portions requested by the user in different arrangements in the UI. In this manner, the embodiments may be configured to coordinate multiple views of wafer data. Coordinating the multiple views of the wafer data may be performed by the UI software module. Multiple views of the wafer data may be used for engineering analysis of wafer inspection results. For example, for a visual comparison of images of different areas on the wafer and/or for a comparison of results of different algorithms (e.g., for algorithm development and/or tuning), the user may navigate among the different portions and compare multiple combinations of the different portions visually by selecting to view the different portions relatively close to each other (e.g., side by side) in different combinations. In this manner, different portions of the image corresponding to different areas that are relatively far apart on the wafer may be displayed relatively close together in the UI (e.g., side-by-side). In addition, the different portions may be displayed in the UI in different arrangements simultaneously or sequentially.

In another embodiment, displaying the different portions includes temporarily storing only the different portions requested by the user and using only the temporarily stored different portions to display only the different portions requested by the user in different arrangements in the UI. In this manner, displaying the requested portions in different arrangements may not involve communicating more than one time with the one or more IMCs in which the different portions are stored. For example, clicking on a scrollbar by a user is an example of how the user can indicate to the embodiments to change the arrangement in which the different portions are displayed. In this manner, clicking on the scrollbar may initiate a UI activity in which the display will be changed in a way that does not require any new communication with the IMCs. Instead, the same wafer tiles may be displayed in the UI, but at different locations. For this purpose, the host software may maintain a cache of wafer tiles that it has recently received. By re-drawing from a local cache instead of talking across a network to the IMCs, the user gets faster interaction.

In an additional embodiment, displaying the different portions in the UI includes displaying only the different portions requested by the user at different resolutions in the UI. For example, in addition to the native pixel resolution, the user may request that the UI display one or more of the different portions of the image at a reduced resolution. In particular, normally inspection is performed at a relatively high pixel resolution (e.g., the native pixel resolution). However, the user may want to view the image of the wafer or an image of some portion of the wafer at a reduced resolution since such resolution may allow the user to identify macroscopic features and/or relatively large scale defects in the image. In this manner, the embodiments may be configured to coordinate multiple views of wafer data at multiple resolutions. Coordinating the multiple views of the wafer data at multiple resolutions may be performed by the UI software module. In addition, multiple views of the wafer data at multiple resolutions may be displayed simultaneously or sequentially.

In some embodiments, the method includes, prior to receiving a request from the user for displaying the different portions, generating one or more additional portions corresponding to each of the different portions by altering a resolution of each of the different portions and separately storing the one or more additional portions with the corresponding different portions. For example, whole wafer display becomes practical if the network communication bandwidth can be fixed by performing any data reduction on the individual IMC nodes. The IMC may provide the host computer with a relatively low resolution wafer tile that contains the same number of pixels as did the native resolution wafer tile. In addition, the data can be generated and stored for a number of different resolution levels. For example, the system may be designed with a variety of resolution levels at which the IMC nodes pre-compute and store data. The number of resolution levels at which the IMC nodes pre-compute and store data (e.g., vs. sub-sample “on the fly” as described further herein) may be selected as a design decision.

In an additional embodiment, the method includes receiving a request from the user for displaying the different portions and a resolution at which displaying the different portions is to be performed and, subsequent to receiving the request and prior to displaying the different portions, changing a resolution of only the different portions requested by the user to the resolution at which displaying the different portions is to be performed. For example, for resolution levels other than those at which the IMC nodes pre-compute and store data, the IMCs may sub-sample data “on the fly” at the time that the request is received.

In some embodiments, separately storing the different portions is performed for multiple wafers, and displaying the different portions includes simultaneously displaying only the different portions of the images of two or more of the multiple wafers requested by the user in the UI. In this manner, the embodiments may be configured to coordinate multiple views of wafer data generated for multiple wafers. For example, one or more different portions of images of more than one wafer may be displayed simultaneously in the UI. Coordinating the multiple views of the wafer data for multiple wafers may be performed by the UI software module.

In one embodiment, displaying the different portions of the image in the UI is not limited by a size of data that can be displayed simultaneously in the UI. In particular, using the embodiments described herein, there is no limit to the size of the wafer data that can be displayed.

In another embodiment, a time in which displaying the different portions of the image in the UI is performed is proportional to a size of a display device on which the UI is displayed and is independent of a size of raw data corresponding to the image of substantially the entire wafer acquired by the inspection of the wafer. In particular, using the embodiments described herein, the time required to display the data is proportional to the size of the computer monitor, not proportional to the size of the raw wafer data.

In another embodiment, if requested by the user, displaying the different portions includes displaying the image of substantially the entire wafer by displaying all of the different portions of the image. In this manner, the embodiments described herein may be configured to display high-volume whole wafer data. In particular, although different portions of the image data may be stored separately and only the requested portions may be displayed, this does not mean that the image data for the whole wafer cannot be displayed efficiently is so requested.

In an additional embodiment, if requested by the user, displaying the different portions of the image in the UI includes displaying the image of substantially the entire wafer by displaying all of the different portions of the image with additional information generated for the wafer overlaid thereon. For example, the embodiments may include using the UI to overlay layers of information in a display, and the layers may include relatively high volume whole wafer data. The additional information may include, but is not limited to, one or more layers that include intensities, defect location indicators (e.g., some indicia indicating the locations of the defects on the wafer), metrology results such as results of atomic force microscopy (AFM) performed on the wafer, defect review results such as results of scanning electron microscopy (SEM) defect review performed on the wafer, design data for one or more layers on the wafer, etc., or some combination thereof Essentially, additional information that can be overlaid with the images or portions of images described herein includes any information about the wafer that is available and accessible at the time of image display. The intensities across the wafer may be, for example, a noise map or other image generated using methods and systems described in commonly assigned U.S. patent application Ser. No. 11/673,150 by Kirk et al. filed Feb. 9, 2007, which is incorporated by reference as if fully set forth herein. Information generated for the wafer that is overlaid with the image of substantially the entire wafer or a portion of the wafer may also include information generated at different steps in the wafer fabrication process. In this manner, the embodiments may be used to overlay images acquired after a progression of steps of the wafer fabrication process. Any of the information described above may be overlaid with the image of the wafer in any suitable manner.

Each of the embodiments of the method described above may include any other step(s) of any other method(s) described herein. In addition, each of the embodiments of the method described above may be performed by any of the systems described herein.

The embodiments described herein provide a number of advantages over other methods and systems for displaying images of a wafer. For example, the embodiments described herein provide efficient display of an image of a wafer acquired from an inspection system, by accommodating relatively large data sizes, by allowing navigation through an image of substantially the entire wafer, by enabling higher throughput of such display, and by allowing flexibility in the platform on which the software for such displaying is implemented such that the platform that allows the best performance can be used.

In particular, the embodiments described herein accelerate the display of wafer images such that users can immediately see the results of wafer inspection. As such, the development and testing of wafer inspection algorithms may be accelerated since algorithm engineers can immediately see the results of their work. In addition, the embodiments described herein are capable of displaying every bit of wafer data. By displaying every bit of data for a wafer, systems engineers can detect problems with an inspection system sooner. Furthermore, the display technology described herein may be available on and/or incorporated into the inspection system as part of the system. Allowing an inspection system customer to view whole wafer data for relatively large data sizes is advantageous since it provides the customer with more information that can then be used to monitor and/or correct a process performed on the wafer.

Another embodiment relates to a carrier medium that includes program instructions executable on a computer system for performing a computer-implemented method for displaying an image of at least a portion of a wafer. One embodiment of such a carrier medium is shown in FIG. 3. In particular, carrier medium 38 includes program instructions 40 executable on computer system 42 for performing a computer-implemented method.

The computer-implemented method includes separately storing different portions of an image of substantially the entire wafer acquired by inspection of the wafer. Separately storing the different portions of the image may be performed according to any of the embodiments described herein. The different portions of the image correspond to different areas on the wafer. The different portions may be configured according to any embodiments described herein. The method also includes displaying in a UI only the different portions requested by a user. Displaying the different portions requested by a user in the UI may be performed according to any of the embodiments described herein.

The computer-implemented method executable on the computer system by the program instructions may include any other step(s) of any other method(s) described herein. In addition, the carrier medium may be further configured as described herein.

Program instructions 40 implementing methods such as those described herein may be transmitted over or stored on carrier medium 38. The carrier medium may be a transmission medium such as a wire, cable, or wireless transmission link. The carrier medium may also be a storage medium such as a read-only memory, a random access memory, a magnetic or optical disk, or a magnetic tape. In addition, program instructions 40 may include two different sets of program instructions. One set of program instructions may be configured to partition the wafer image and to separately store different portions of the wafer image as described further herein. A different set of program instructions may be configured to orchestrate display of the different portions of the wafer image according to any of the embodiments described herein. In this manner, the program instructions that create and store the wafer image data may be decoupled from the program instructions that control display of the wafer image data.

Computer system 42 may take various forms, including a personal computer system, mainframe computer system, workstation, IMC, parallel processor, or any other device known in the art. In general, the term “computer system” may be broadly defined to encompass any device having one or more processors, which executes instructions from a memory medium. In addition, computer system 42 may be configured to perform all of the functions of the IMC master, the host computer, and the IMC nodes described above. However, in other embodiments, computer system 42 may be replaced with one or more other computer systems, which may be configured according to any of the embodiments described herein. In such embodiments, program instructions 40 may be configured such that different functions (which may be executed by different, decoupled sets of program instructions) are performed on different computer systems.

An additional embodiment relates to a system configured to display an image of at least a portion of a wafer. One embodiment of such a system is shown in FIG. 3. For example, as shown in FIG. 3, the system includes inspection system 44 configured to acquire an image of substantially an entire wafer by inspecting the wafer. The inspection system may be configured to inspect the wafer in any suitable manner. In addition, the inspection system may include an existing inspection system such as the Puma 9000 and 9100 series of tools that are commercially available from KLA-Tencor, San Jose, Calif. For some such systems, the methods described herein may be provided as optional functionality of the existing inspection system (e.g., in addition to other functionality of the system). Alternatively, the inspection system described herein may be designed “from scratch” to provide a completely new system. In another embodiment, the inspection system may be an electron beam inspection system. Examples of commercially available electron beam inspection systems that may be included in the system include the eS25, eS30, and eS31 systems from KLA-Tencor.

The system also includes computer system 42 configured to separately store different portions of the image. The computer system may be configured to separately store the different portions of the image according to any of the embodiments described herein. The different portions of the image correspond to different areas on the wafer. The different portions and the different areas may be configured as described further herein. The computer system is also configured to display in a UI only the different portions requested by a user. The computer system may be configured to display the different portions requested by the user according to any embodiments described further herein. Computer system 42 may be configured to perform any other step(s) of any of the method embodiment(s) described herein.

In embodiments of the system that include inspection system 44, computer system 42 may be coupled to the inspection system in any manner known in the art. For example, computer system 42 may be coupled to a computer system (not shown) of inspection system 44 such that computer system 42 can receive results of inspection generated by the inspection system. In addition, computer system 42 may receive any output of the detector(s) (not shown) of the detection channel(s) (not shown) of the inspection system such as image data and signals.

Although the embodiments are shown in FIGS. 1 and 3 as including an inspection system, it is to be understood that the system embodiments described herein may not include an inspection system and the method embodiments described herein may not necessarily use an inspection system. For example, computer system 42 and other computer systems described herein may be configured as stand-alone systems that do not form part of a process, inspection, metrology, review, or other tool. In such an embodiment, computer system 42 and other computer systems described herein may be configured to receive and/or acquire data or information from other systems (e.g., inspection results from an inspection system and/or a fab database) by a transmission medium that may include “wired” and/or “wireless” portions. In this manner, the transmission medium may serve as a data link between the computer system and the other system. In addition, computer system 42 and other computer systems described herein may send data to another system via the transmission medium. Alternatively, computer system 42 may form part of the inspection system or other tool. For example, computer system 42 may be included in an inspection system.

The embodiments of the system shown in FIG. 3 may be further configured as described herein. In addition, the system may be configured to perform any other step(s) of any of the method embodiment(s) described herein.

Further modifications and alternative embodiments of various aspects of the invention may be apparent to those skilled in the art in view of this description. For example, computer-implemented methods, carrier media, and systems for displaying an image of at least a portion of a wafer are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A computer-implemented method for displaying an image of at least a portion of a wafer, comprising:
separately storing different portions of an image of substantially an entire wafer acquired by inspection of the wafer, wherein the different portions of the image correspond to different areas on the wafer, and wherein said separately storing the different portions comprises separately storing the different portions in one or more storage media in one or more image computers;
displaying in a user interface only the different portions requested by a user; and
prior to receiving a request from the user for said displaying, generating one or more additional portions corresponding to each of the different portions by altering a resolution of each of the different portions and separately storing the one or more additional portions in the same storage media as the corresponding different portions of the image of the wafer acquired by the inspection of the wafer.

2. The method of claim 1, wherein the different areas do not overlap on the wafer.

3. The method of claim 1, wherein the different areas are adjacent to one another on the wafer such that the different areas cover substantially the entire wafer.

4. The method of claim 1, wherein the different areas comprise rectangular areas on the wafer arranged in a two-dimensional grid.

5. (canceled)

6. The method of claim 1, wherein said separately storing the different portions and said displaying are performed by different software modules.

7. The method of claim 1, wherein said displaying comprises sending one or more requests for the different portions requested by the user to the one or more image computers.

8. The method of claim 1, wherein said displaying comprises receiving the request from the user for the different portions to be displayed in the user interface, distributing the request to the one or more image computers, and receiving the different portions requested by the user from the one or more image computers.

9. The method of claim 1, wherein said displaying comprises displaying only the different portions requested by the user in different arrangements in the user interface.

10. The method of claim 1, wherein said displaying comprises temporarily storing only the different portions requested by the user and using only the temporarily stored different portions to display only the different portions requested by the user in different arrangements in the user interface.

11. The method of claim 1, wherein said displaying comprises displaying only the different portions requested by the user at different resolutions in the user interface.

12. The method of claim 1, wherein said separately storing the different portions comprises separately storing the different portions at a resolution at which the different portions are acquired.

13. (canceled)

14. The method of claim 1, further comprising receiving the request from the user for said displaying and a resolution at which said displaying is to be performed and, subsequent to said receiving and prior to said displaying, changing a resolution of only the different portions requested by the user to the resolution at which said displaying is to be performed.

15. The method of claim 1, wherein said displaying is not limited by a size of data that can be displayed simultaneously in the user interface.

16. The method of claim 1, wherein a time in which said displaying only the different portions of the image acquired by the inspection of the wafer is performed is proportional to a size of a display device on which the user interface is displayed and is independent of a size of raw data corresponding to the image of substantially the entire wafer acquired by the inspection of the wafer.

17. The method of claim 1, wherein said separately storing the different portions is performed for multiple wafers, and wherein said displaying comprises simultaneously displaying only the different portions of the images of two or more of the multiple wafers requested by the user in the user interface.

18. The method of claim 1, wherein, if requested by the user, said displaying comprises displaying the image of substantially the entire wafer by displaying all of the different portions of the image.

19. The method of claim 1, wherein, if requested by the user, said displaying comprises displaying the image of substantially the entire wafer by displaying all of the different portions of the image with additional information generated for the wafer overlaid thereon.

20. A storage medium, comprising program instructions executable on a computer system for performing a computer-implemented method for displaying an image of at least a portion of a wafer, wherein the computer-implemented method comprises:
separately storing different portions of an image of substantially an entire wafer acquired by inspection of the wafer, wherein the different portions of the image correspond to different areas on the wafer, and wherein said separately storing the different portions comprises separately storing the different portions in one or more storage media in one or more image computers;
displaying in a user interface only the different portions requested by a user; and
prior to receiving a request from the user for said displaying, generating one or more additional portions corresponding to each of the different portions by altering a resolution of each of the different portions and separately storing the one or more additional portions in the same storage media as the corresponding different portions of the image of the wafer acquired by the inspection of the wafer.

21. A system configured to display an image of at least a portion of a wafer, comprising:
an inspection system configured to acquire an image of substantially an entire wafer by inspecting the wafer; and
a computer system configured to:
separately store different portions of the image in one or more storage media in one or more image computers, wherein the different portions of the image correspond to different areas on the wafer;
display in a user interface only the different portions requested by a user; and
prior to receiving a request from the user for said displaying, generate one or more additional portions corresponding to each of the different portions by altering a resolution of each of the different portions and separately store the one or more additional portions in the same storage media as the corresponding different portions of the image of the wafer acquired by the inspecting of the wafer.
